(19) United States
(12) Patent Application Publication
(10) Pub. No.: US 2014/0036160 A1
(43) Pub. Date: Feb. 6, 2014

(54) LED LIGHT GUIDE, LED LIGHT SOURCE MODULE AND DIRECT-TYPE LED TV

(71) Applicant: HON HAI PRECISION INDUSTRY CO., LTD., New Taipei (TW)

(72) Inventor: I-THUN LIN, New Taipei (TW)

(73) Assignee: HON HAI PRECISION INDUSTRY CO., LTD., New Taipei (TW)

(21) Appl. No.: 13/711,658

(22) Filed: Dec. 12, 2012

(30) Foreign Application Priority Data
Aug. 1, 2012 (TW) 101127836

(51) Int. Cl. F21V 8/00

(52) U.S. Cl. CPC G02B 6/0068
USPC 348/739; 362/607

(57) ABSTRACT

An LED light guide includes a top surface and an opposite bottom surface, the bottom surface includes a number of concave lens portions, and the top surface includes a number of convex lens portions. The concave lens portions are each aligned with a convex lens portion, and each of the concave lens portions forms a receiving space for accommodating an LED. An LED module and a direct-type LED TV using the LED light guide are also provided.

### CROSS-REFERENCE TO RELATED APPLICATION

This application is related to a commonly-assigned co-pending application entitled “LED LIGHT GUIDE, LED LIGHT SOURCE MODULE AND DIRECT-TYPE LED TV” (Atty. Docket No. US46324). The above-identified application is filed simultaneously with the present application. The entire disclosure of the above-identified application is incorporated herein by reference.

### BACKGROUND

1. Technical Field

The present disclosure relates to an LED light guide, and an LED light source module and a direct-type LED TV using the LED light guide.

2. Description of Related Art

Light emitting diodes (LEDs) are used as point light sources. In order to make the LED light diffuse and disperse correctly, a diffusion plate with light scattering particles dispersed therein is arranged above the LEDs. However, hot spots may form on the diffusion plate, and in order to avoid the hot spots, a certain distance between the LED and the diffusion plate has to be maintained; therefore, the minimum thickness of an LED light source module and a direct-type LED TV is limited.

What is needed, therefore, is an LED light guide, LED light source module and direct-type LED TV, which can overcome the above shortcomings

### BRIEF DESCRIPTION OF THE DRAWINGS

Many aspects of the present LED light guide, LED light source module and direct-type LED TV can be better understood with reference to the following drawings. The components in the drawings are not necessarily drawn to scale, the emphasis instead being placed upon clearly illustrating the principles of the present LED light guide, LED light source module and direct-type LED TV. Moreover, in the drawings, like reference numerals designate corresponding parts throughout the several views.

FIG. 1 is a schematic isometric view of an LED light guide in accordance with a first embodiment.

FIG. 2 is similar to FIG. 1, but is viewed from an opposite direction.

FIG. 3 is a schematic isometric view of an LED light guide in accordance with a second embodiment.

FIG. 4 is a schematic isometric view of an LED light source module in accordance with an embodiment.

FIG. 5 is a cross sectional view of the LED light source module of FIG. 4 taken along line V-V.

FIG. 6 is a schematic cross sectional view of a direct-type LED TV in accordance with an embodiment.

### DETAILED DESCRIPTION

Embodiments of the present LED light guide, LED light source module and direct-type LED TV will be described with reference to the drawings.

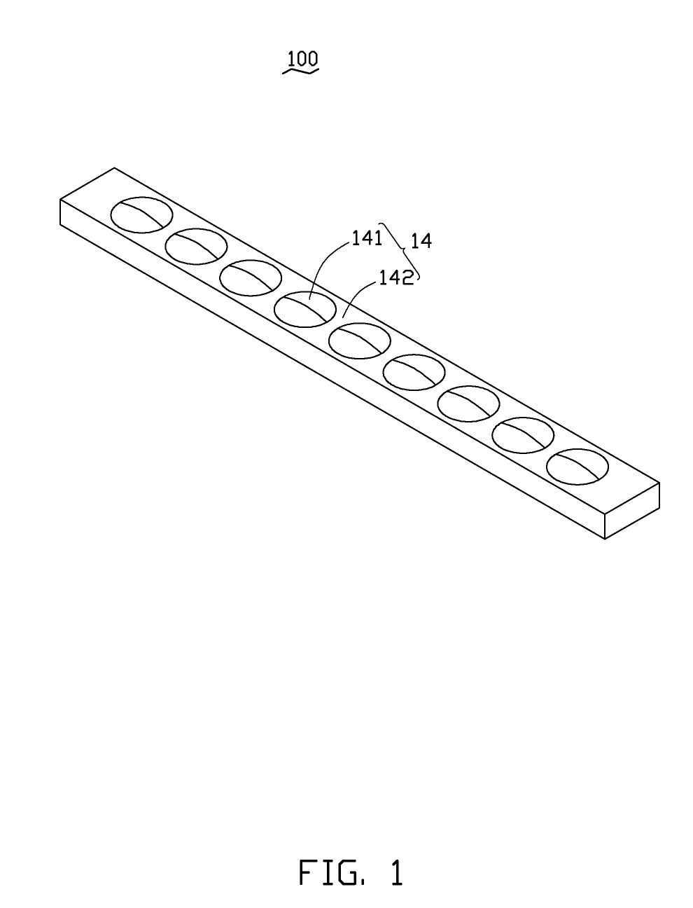

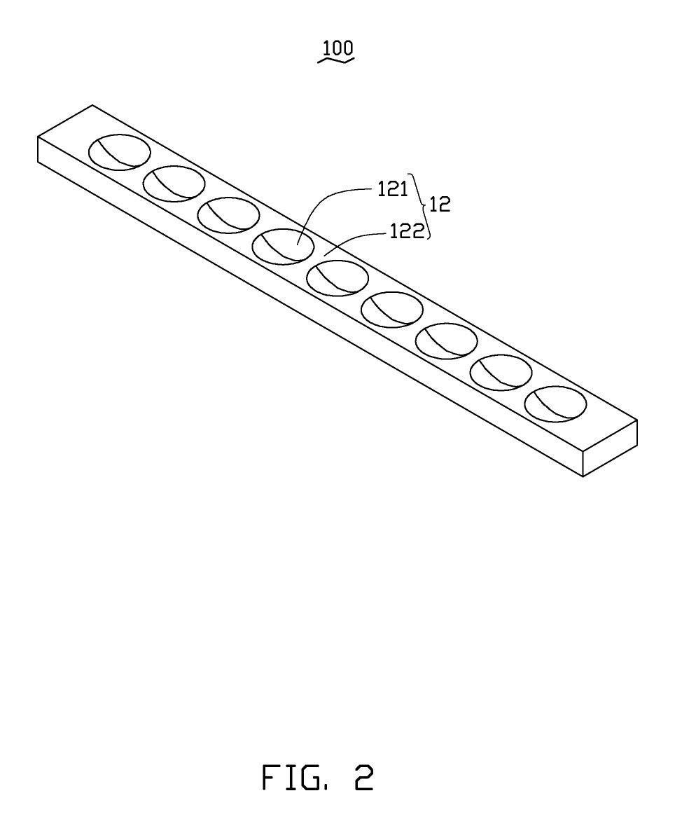

Referring to FIGS. 1 and 2, an LED light guide 100 in accordance with a first embodiment is provided. The LED light guide 100 includes a bottom surface 12 and a top surface 14 opposite to the bottom surface 12. In the present embodiment, the LED light guide 100 is an elongated rectangular shape.

The bottom surface 12 includes a first planar portion 122 and a plurality of concave lens portions 121, and the top surface 14 includes a second planar portion 142 and a plurality of convex lens portions 141. Every two adjacent concave lens portions 121 are connected by the first planar portion 122, and every two adjacent convex lens portions 141 are connected by the second planar portion 142. The concave lens portions 121 are each aligned with a corresponding one of the convex lens portions 141. Each of the concave lens portions 121 and the convex lens portions 141 can have a spherical or an aspheric surface.

Each of the concave lens portions 121 forms a receiving space 123 for receiving an LED therein. As the concave lens portion 121 naturally has a certain distance from the LED, and the concave lens portion 121 can be a first diffusion stage for the LED light, a hot spot on the LED light guide 100 can be reduced or removed. The convex lens portions 141 further diffuse the LED light, thereby improving the diffusion effect.

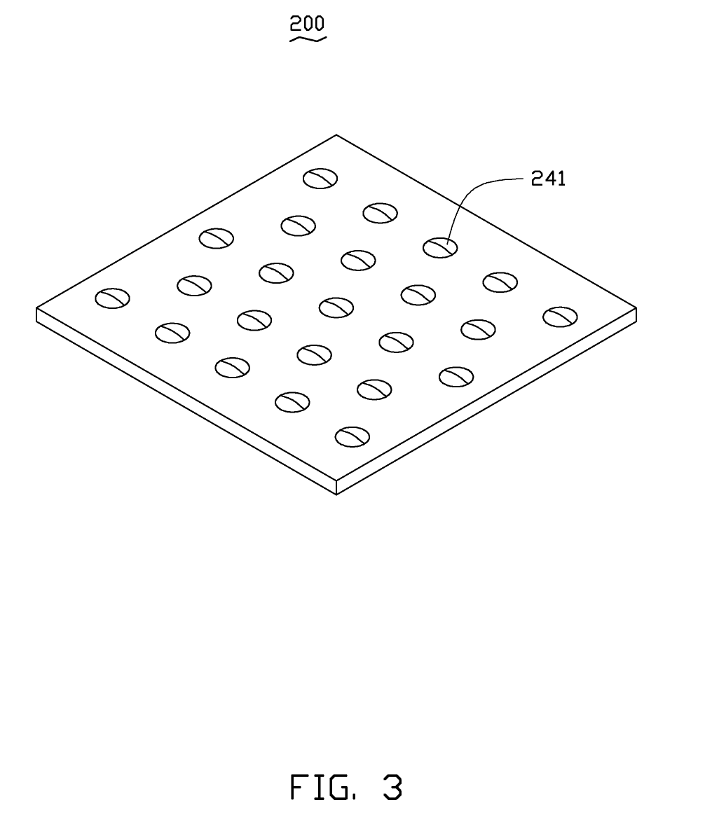

Referring to FIG. 3, an LED light guide 200 in accordance with a second embodiment is provided. The LED light guide 200 is similar to LED light guide 100; however, the LED light guide 200 is a square plate. A plurality of convex lens portions 141 are arranged in an array, and a plurality of concave lens portions (not shown) are opposite to and aligned with matching convex lens portions 141.

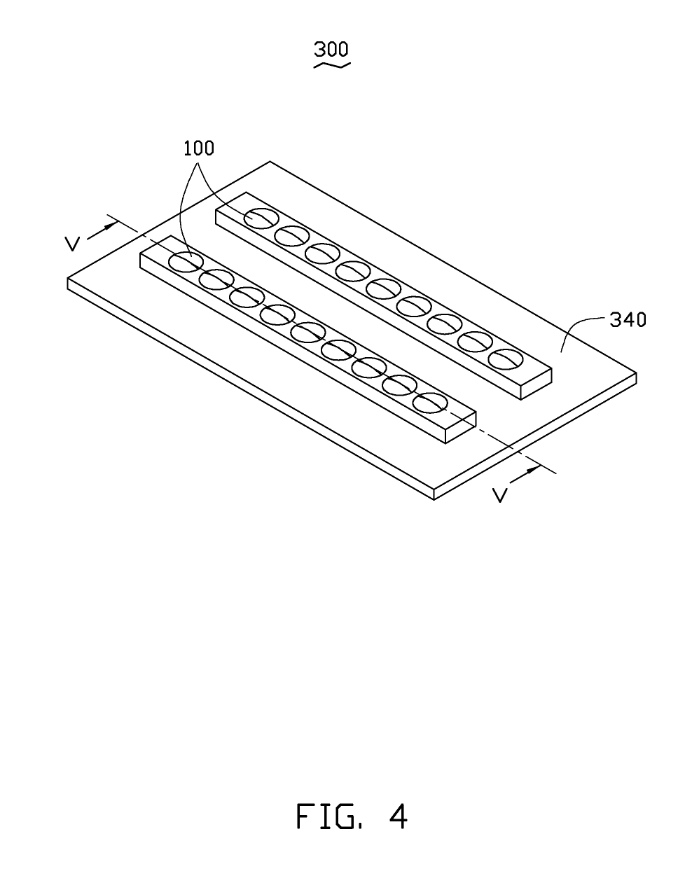

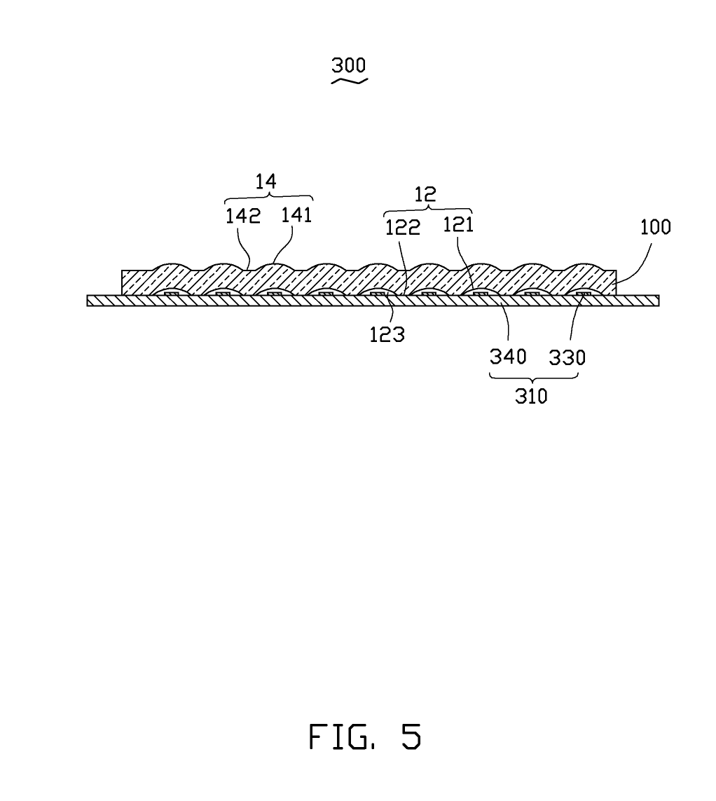

Referring to FIGS. 4 and 5, an LED light source module 300 includes an LED module 310 and a plurality of LED light guides 100. The LED module 310 includes a printed circuit board 340 and a plurality of LEDs 330 arranged in an array on the printed circuit board 340. The first planar portion 122 of the bottom surface 12 of each of the LED light guides 100 is attached to the printed circuit board 340, and each of the LEDs 330 is received in the receiving space 123 existing in each concave lens portion 121.

As the concave lens portions 121 provide a first diffusion stage for the LED light, the bottom surface 12 of each of the LED light guides 100 contacts the printed circuit board 340 without promoting or allowing any hot spot on the LED light guides 100. That is, a distance between each of the LED light guides 100 and each of the LEDs 330 can be significantly decreased. As the convex lens portions 141 further diffuses the LED light, no extra diffusion plates are required in the entire LED light source module 300.

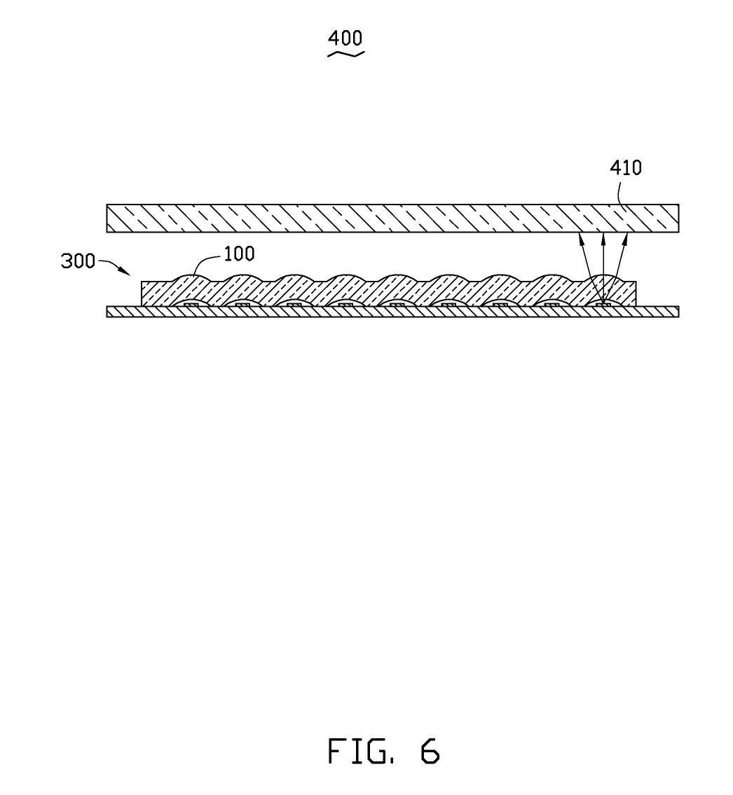

Referring to FIG. 6, a direct-type LED TV 400 includes a display panel 410 arranged above the LED light guides 100 of the LED light source module 300. The display panel 410 receives light travelling through the LED light guides 100. The LED TV 400 does not need extra diffusion plates between the display panel 410 and the LED light source module 300.

As the LED light source module 300 can be very thin, the direct-type LED TV 400 can be correspondingly thin.

It is understood that the above-described embodiments are intended to illustrate rather than limit the disclosure. Variations may be made to the embodiments and methods without departing from the spirit of the disclosure. Accordingly, the appended claims should be construed broadly and in a manner consistent with the scope of the disclosure.

What is claimed is:

1. An LED light guide comprising a top surface and an opposite bottom surface, the bottom surface comprising a plurality of concave lens portions, the top surface comprising a plurality of convex lens portions, the concave lens portions aligned with the respective convex lens portions, each of the concave lens portions forming a receiving space configured for receiving an LED therein.

2. The LED light guide of claim 1, wherein the bottom surface further comprises a first planar portion, and each two adjacent of the concave lens portions are connected by the first planar portion.

3. The LED light guide of claim 2, wherein the top surface further comprises a second planar portion, and each two adjacent of the convex lens portions are connected by the second planar portion.

4. The LED light guide of claim 3, wherein the concave lens portions are arranged in an array and the convex lens portions are arranged in an array.

5. An LED light source module, comprising:
an LED light guide comprising a top surface and an opposite bottom surface, the bottom surface comprising a plurality of concave lens portions, the top surface comprising a plurality of convex lens portions, the concave lens portions aligned with the respective convex lens portions, each of the concave lens portions forming a receiving space; and
an LED module comprising a printed circuit board and plurality of LEDs mounted on the printed circuit board with the LEDs received in the respective receiving spaces of the LED light guide.

6. The LED light source module of claim 5, wherein the bottom surface further comprises a first planar portion, and each two adjacent of the concave lens portions are connected by the first planar portion.

7. The LED light source module of claim 6, wherein the top surface further comprises a second planar portion, and each two adjacent of the convex lens portions are connected by the second planar portion.

8. The LED light source module of claim 7, wherein the concave lens portions are arranged in an array and the convex lens portions are arranged in an array.

9. The LED light source module of claim 6, wherein the first planar portion is attached to and in contact with the printed circuit board.

10. A direct-type LED TV, comprising:
an LED light guide comprising a top surface and an opposite bottom surface, the bottom surface comprising a plurality of concave lens portions, the top surface comprising a plurality of convex lens portions, the concave lens portions aligned with the respective convex lens portions, each of the concave lens portions forming a receiving space; and
an LED module comprising a printed circuit board and plurality of LEDs mounted on the printed circuit board with the LEDs received in the respective receiving spaces of the LED light guide; and
a display panel arranged on the LED light guide and receiving light directly from the LED light guide.

11. The direct-type LED TV of claim 10, wherein the bottom surface further comprises a first planar portion, and each two adjacent of the concave lens portions are connected by the first planar portion.

12. The direct-type LED TV of claim 11, wherein the top surface further comprises a second planar portion, and each two adjacent of the convex lens portions are connected by the second planar portion.

13. The direct-type LED TV of claim 12, wherein the concave lens portions are arranged in an array and the convex lens portions are arranged in an array.

14. The direct-type LED TV of claim 11, wherein the first planar portion is attached to and in contact with the printed circuit board.
